(19) United States
(12) Patent Application Publication
(10) Pub. No.: US 2024/0296461 A1
(43) Pub. Date: Sep. 5, 2024

(54) AUTOMATICALLY MAINTAINING CONTENT DATA ON A COMPLIANCE PLATFORM

(71) Applicant: MASTERCARD INTERNATIONAL INCORPORATED, PURCHASE, NY (US)

(72) Inventors: Joseph BEYER, Lake St Louis, MO (US); Alex John TETREAULT, Webster Groves, MO (US)

(21) Appl. No.: 18/178,493

(22) Filed: Mar. 3, 2023

(51) Int. Cl. G06Q 30/018

(52) U.S. Cl. CPC G06Q 30/018

(57) ABSTRACT

The disclosure herein describes automatically maintaining and updating content data on a compliance platform. Case content data is obtained from a compliance platform and cached in a case cache, including user content data and team content data associated with users of cases on the compliance platform. Team content data is then obtained from a team data platform and cached in a team cache. User content data and team content data on the compliance platform that needs to be updated is identified using the cached case content data and the cached data in the team cache. Up-to-date content data corresponding to the identified user content data and identified team content data from a user data platform and the team cache is then used to update compliance cases on the compliance platform. The compliance cases of the compliance platform are updated periodically and automatically using the described processes.

### BACKGROUND

Modern compliance and e-discovery platforms enable the collection and secure storage of data that is needed for associated cases. However, the complexity of the data sets to be stored increases as the methods by which users create and interact with data increase. Maintaining up-to-date data in compliance and e-discovery platforms is difficult to do in an efficient way and often requires some degree of manual task performance by users.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for automatically maintaining and updating content data on a compliance platform is described. Case content data is obtained from a compliance platform and cached in a case cache, including user content data and team content data associated with users of cases on the compliance platform. Team content data is then obtained from a team data platform and cached in a team cache. User content data and team content data on the compliance platform that needs to be updated is identified using the cached case content data and the cached data in the team cache. Up-to-date content data corresponding to the identified user content data and identified team content data from a user data platform and the team cache is then used to update compliance cases on the compliance platform.

### BRIEF DESCRIPTION OF THE DRAWINGS

The present description will be better understood from the following detailed description read in light of the accompanying drawings, wherein:

FIG. 1 is a block diagram illustrating a system configured to collect compliance data for storage in a compliance platform;

FIG. 2 is a flowchart illustrating a method for building cached case content data in a case cache from a compliance platform;

FIG. 3 is a flowchart illustrating a method for building a team cache from a team data platform;

FIG. 4 is a flowchart illustrating a method for updating cases on a compliance platform using a case cache and a team cache;

FIG. 5 is a flowchart illustrating a method for caching content data and then updating compliance cases on a compliance platform using the cached content data; and

FIG. 6 illustrates an example computing apparatus as a functional block diagram.

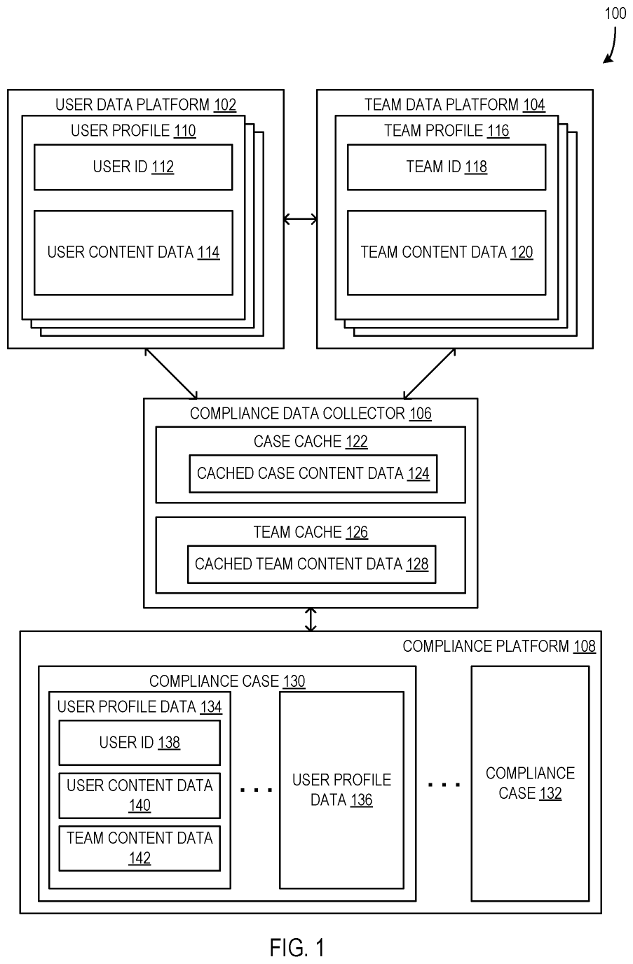

Corresponding reference characters indicate corresponding parts throughout the drawings. In FIGS. 1 to 6, the systems are illustrated as schematic drawings. The drawings may not be to scale.

### DETAILED DESCRIPTION

Aspects of the disclosure provide a computerized method and system for automatically maintaining and updating content data in a compliance platform, including user content data and team content data associated with users of compliance cases therein. Data of a compliance case is obtained from a compliance platform and cached in a case cache, enabling the disclosure to efficiently analyze the cached case content data without excessively taxing connections to the compliance platform. Team content data is then obtained from a team data platform and cached in a team cache. User content data and team content data on the compliance platform that needs to be updated is identified using the cached case content data and the cached data in the team cache. In some examples, the identification of such data to be updated is based at least in part on analysis of associated timestamps as described herein. Up-to-date content data corresponding to the identified user content data and identified team content data from a user data platform and the team cache is then used to update compliance cases on the compliance platform.

The disclosure operates in an unconventional manner at least by automatically obtaining both user content data associated with users of compliance cases and team content data associated teams of which those users are members or otherwise associated. By obtaining data both from user data platforms and team data platforms in the same process, the resources and time required to update those data on the compliance platform are reduced and associated efficiency is increased. For instance, by enabling user content data and team content data to be updated on the compliance platform as described, the use of bandwidth and command time to interact with the compliance platform can be carefully managed and limitations enforced by the compliance platform can be avoided.

Further, the disclosure describes the use of timestamps to determine when to update portions of data in the compliance platform. By defining and using timestamp thresholds as described herein, the disclosure improves the resource use efficiency and reduces the time required to periodically perform the processes described herein. Attempting to update all data in the compliance platform each time the described processes are performed would result in extremely expensive and time-intensive iterations of the processes, such that performing them would be impractical. The use of the described timestamp analysis enables the disclosure to balance reduced system resource usage and time requirements and ensuring that the data on the compliance platform is sufficiently up to date.

Additionally, the disclosure describes the use of parallel threads to interact with the compliance platform in a way that increases the resource and time efficiency of the performance of the processes while ensuring that the disclosed processes do not exceed the limitations enforced by the compliance platform. For instance, in some examples, the disclosed processes interact with the compliance platform using two parallel threads when the compliance platform limits such parallel thread interactions to three parallel threads. In such examples, the disclosed processes use just two parallel threads, reserving the third available parallel thread for reacting to issues with the other two parallel threads.

Still further, the disclosure describes the use of automatic command time throttling to avoid more significant throttling that would be enforced by the compliance platform. The disclosed processes send commands to the compliance platform and monitor the time taken for processing those commands. As the quantity of time taken to process those commands approaches a command time limit imposed by the compliance platform, the disclosed processes reduce the frequency of commands sent. While this reduces the rate at which the processes are performed, it avoids more significant command processing throttling that would be imposed by the compliance platform, therefore improving the time efficiency of performing those processes over time.

Additionally, the disclosure specifically describes automatically obtaining, caching, and updating private communication channels associated with teams of users in compliance cases. In many other solutions, such private communication channels are not considered by the automatic content data collection processes. By including these private communication channels in the disclosed processes, the overall time required to update the corresponding team content data on the compliance platform is significantly reduced and required manual effort by users of the data collection processes is reduced as well.

FIG. 1 is a block diagram illustrating a system 100 configured to collect compliance data (e.g., user content data 140 and/or team content data 142) for storage in a compliance platform 108. In some examples, a compliance data collector 106 collects data from a user data platform 102 and a team data platform 104 and provides the collected data to a compliance platform 108 in which data for compliance cases 130-132 are maintained. Further, in some examples, the compliance data collector 106 is configured to automatically collect data from the platforms 102-104 based on corresponding data on the compliance platform 108 becoming stale, such that the compliance data collector 106 updates stored data on the compliance platform 108 with data collected from the platforms 102-104.

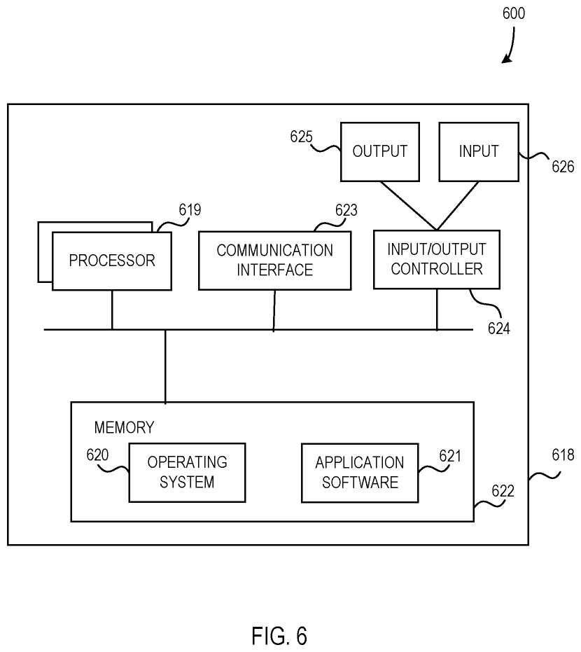

In some examples, the system 100 includes a computing device, such as the computing device of FIG. 6. Further, in some examples, the system 100 includes multiple computing devices that are configured to communicate with each other via one or more communication networks (e.g., an intranet, the Internet, a cellular network, other wireless network, other wired network, or the like). In some such examples, entities of the system 100 are configured to be distributed between the multiple computing devices and to communicate with each other via network connections. For instance, in an example, user data platform 102, team data platform 104, and compliance data platform 108 are located and/or executed on separate computing devices. The compliance data collector 106 is configured to be executed on one or more computing devices and to facilitate the transfer of compliance data between the computing devices of the user data platform 102 and team data platform 104 to the compliance platform 108 via a communication network as described herein. In other examples, other arrangements or organizations of multiple computing devices are used in the system 100 without departing from the description.

In some examples, the system 100 is configured to collect and store data associated with compliance cases 130-132 of the compliance platform 108. In some such examples, the data stored by the compliance platform 108 is used to prove that an associated organization, group, or user is complying with established laws, policies, or other rules that have been established by a government, agency, or other organization. In some examples, policies with which compliance must be shown include privacy-based policies, risk-based policies, government information security-based policies, or the like. For instance, in an example, the communications by some users within an organization are collected and stored to prove that those users are not sharing private information improperly based on established privacy policies and/or practices. It should be understood that, in some examples, the compliance platform 108 and associated components of the system 100 are configured to collect and store compliance data in association with one or more compliance cases 130-132 which are associated with one or more different compliance policies. Thus, in some cases, the types of compliance data stored in a compliance case 130 are the same as the types of compliance data stored in a compliance case 132 while, in other cases, the types of compliance data stored in the compliance case 130 differ from the types of compliance data stored in the compliance case 132 based on differing requirements of associated compliance policies. In other examples, more, fewer, or different types of compliance data are collected and stored based on more, fewer, or different types of compliance policies without departing from the description.

In some examples, the user data platform 102 includes hardware, firmware, and/or software that is configured to store and/or enable interaction with user profiles 110 and as associated user content data 114. For instance, in an example, the user data platform 102 stores user content data 114 including the associated user's files and other data stored in cloud data storage or other data storage of the system 100 and/or the associated user's email inbox, archive, and/or other email communication data associated with the system 100. A user's user profile 110 is identified by a user identifier or user ID 112, which is a data value that uniquely or pseudo-uniquely identifies the user, at least within the context of the system 100.

Similarly, in some examples, the team data platform 104 includes hardware, firmware, and/or software that is configured to store and/or enable interaction with team profiles 116 and associated team content data 120. For instance, in an example, the team data platform 104 stores team content data 120 including team membership data (e.g., a list of users that are members of the team), public team member communications and interactions (e.g., meetings scheduled between team members, documents or files shared between team members, or the like), and private team member communications and interactions (e.g., communications within private channels between team members) within the system 100. A team's team profile 116 is identified by a team identifier or team ID 118, which is a data value that uniquely or pseudo-uniquely identifies the team, at least within the context of the system 100.

In some examples, user profiles 110 of users are linked to team profiles 116 of teams of which the users are a part. These links are represented at least by team content data 120 that identifies the members of the team. Further, in some examples, the user profile 110 of a user includes user content data 114 that identifies each team of which the user is a part (e.g., a list of team IDs 118 stored in the user content data 114).

In some examples, the compliance data collector 106 includes hardware, firmware, and/or software configured to collect data from the platforms 102 and 104, cache data in caches 122 and 126, and provide such data to the compliance platform 108 to ensure that the data stored in compliance cases 130-132 thereof are up to date. In some such examples, the compliance data collector 106 includes one or more scripts, programs, or applications that are configured to cache data and/or provide data to the compliance platform 108 as described herein. Further, in some examples, the compliance data collector 106 includes data stores that are used as the case cache 122 and/or the team cache 126 as described herein.

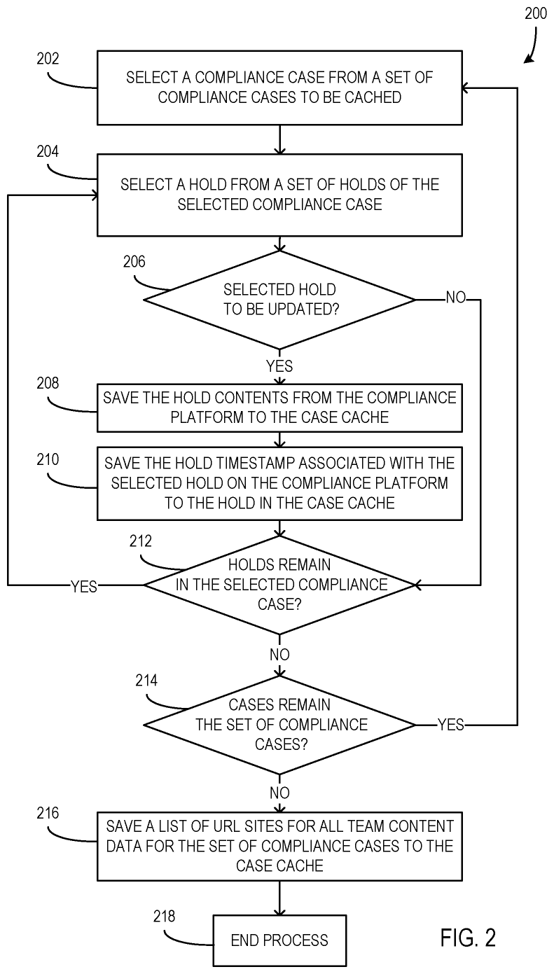

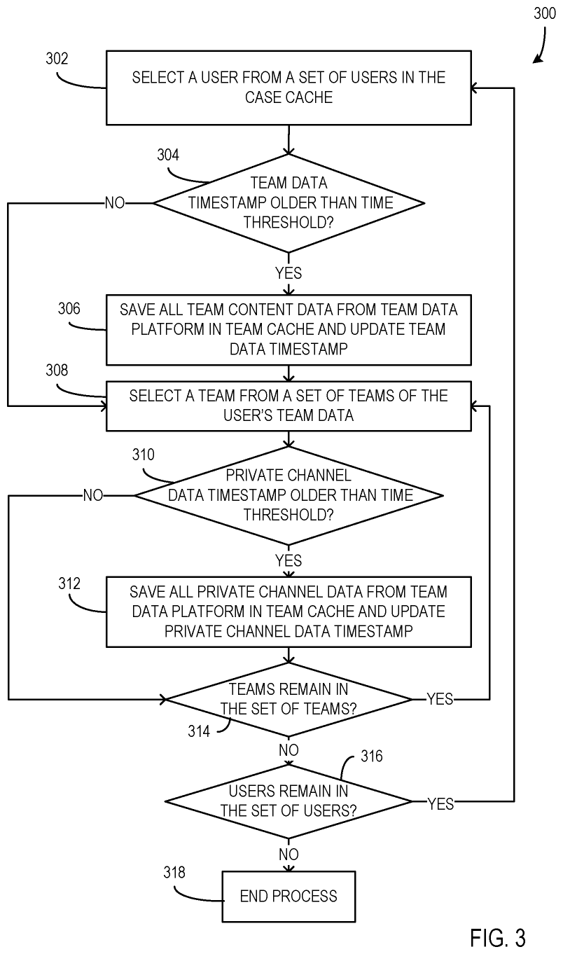

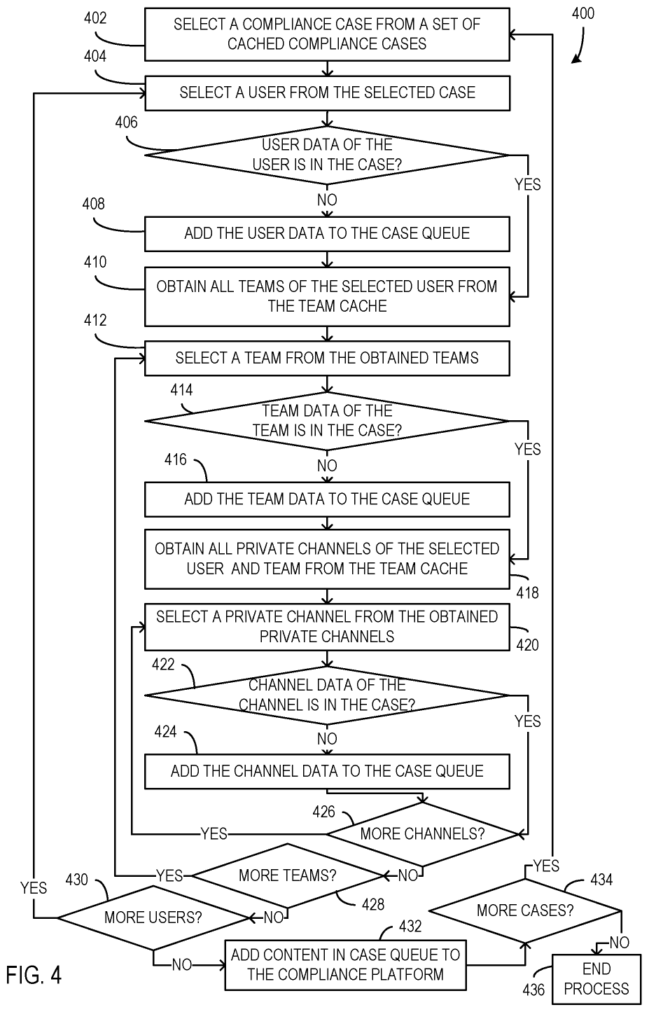

In some examples, the compliance data collector 106 is configured to perform three processes. The first process collects cases and associated users from the compliance platform 108 and stores the collected data as a cached case content data 124 in the case cache 122 for use in the other processes (see FIG. 2 and the associated description below for an example). The second process collects team content data 120 from the team data platform 104 and stores it as cached team content data 128 in the team cache 126 (see FIG. 3 and the associated description below for an example). The third process then uses the cached case content data 124 and the cached team content data 128 to determine compliance data that is present in the platforms 102-104 and not currently present in the compliance cases 130-132 of the compliance platform 108. The determined compliance data is then provided to the compliance platform 108 by the compliance data collector 106, such that the compliance cases 130-132 of the compliance platform 108 are brought up to date (see FIG. 4 and the associated description below for an example).

The compliance cases 130-132 of the compliance platform 108 are configured to store content data associated with users that are associated with the compliance case. In some examples, the compliance platform 108 is configured to receive and store user profile data of one or more users (e.g., user profile data 134) for each compliance case 130-132. Further, the compliance platform 108 enables the stored content data to be accessed and reviewed to determine whether associated users are complying with a policy or the like associated with the compliance case. In some examples, as illustrated, user profile data 134 includes a user ID 138 of the user with which the profile is associated, user content data 140, and team content data 142. Further, in some such examples, the user content data 140 is obtained from the user data platform 102 and the team content data 142 is obtained from the team data platform 104 by operations of the compliance data collector 106 as described herein. Additionally, or alternatively, in some examples, the user profile data 134-136 stored in compliance cases 130-132 of the compliance platform 108 include timestamps that indicate when the data was obtained and/or stored in the platform 108. Such timestamps are used by the compliance data collector 106 to determine how to update stored data as described herein.

Further, in some examples, the cases 130-132 in the compliance platform 108 are stored using data structures called holds, which are of a finite, consistent size. In such examples, each case 130-132 uses at least one hold and some cases use multiple holds. As the quantity of data stored for a case increases, additional holds are assigned to the case for storage of associated data as described herein. In some such examples, the timestamps described herein are associated with holds of cases and those timestamps indicate a last time that data within the hold was changed. Thus, when the compliance data collector 106 is determining whether data of the compliance case needs to be updated with data from the user data platform 102 and/or team data platform 104, the compliance data collector 106 is configured to check the timestamp of the holds of the case and determine which holds of the case have stale data (e.g., data that needs to be updated based on defined time thresholds for data). In other examples, other types of data structures and/or timestamp-based processes are used without departing from the description.

FIG. 2 is a flowchart illustrating a method 200 for building cached case content data in a case cache from a compliance platform. In some examples, the method 200 is executed or otherwise performed by a compliance data collector 106 or another component of a system such as system 100 of FIG. 1. Further, in some examples, the method 200 builds a cache of case content data 124 in a compliance data collector 106, which includes both user and team content. In such examples, the case cache 122 of the collector 106 is a map of a case to the associated case content data.

As described above, in some examples, the case cache 122 stores data in holds. In some such examples, the method 200 is configured to build the cached case content data 124 in the case cache 122 hold by hold as described herein.

At 202, a compliance case is selected from a set of compliance cases to be cached. In some examples, the set of compliance cases to be cached includes all compliance cases in the associated compliance platform. Alternatively, the set of compliance cases is a subset of the set of all compliance cases in the compliance platform and that set is determined based on parameters provided to the compliance data collector 106 through an interface or other function of the compliance data collector 106. Further, in some examples, the set of compliance cases to be cached includes a single compliance case, such that the single compliance case is selected at 202.

In some examples, the set of compliance cases in 202 is determined based on associated timestamps of data already stored in the case cache and timestamps of corresponding data on the compliance platform. In some examples, the method 200 is configured to only build or update a case or user data in the cached case content data if timestamps on existing cached data are different than corresponding timestamps on the compliance platform (e.g., “last modified” timestamps associated with specific data holds as described herein).

At 204, a hold from a set of holds of the selected compliance case is selected. In some examples, the set of holds of the selected compliance case includes all holds of that selected compliance case. Alternatively, the set of holds includes a subset of the set of all holds of the selected compliance case. Further, in some examples, the set of holds includes a single hold, such that the single hold is selected at 204.

At 206, if the selected hold needs to be updated in the case cache, the process proceeds to 208. Alternatively, if the selected hold does not need to be updated in the case cache, the process proceeds to 212. In some examples, determining whether the selected hold needs to be updated includes checking the hold ID and timestamp of the selected hold in the compliance platform (e.g., compliance platform 108). If the checked hold ID and timestamp already exist in the case cache, the selected hold does not need to be updated. Alternatively, if the timestamp associated with the checked hold ID in the case cache differs from the corresponding timestamp on the compliance platform or the checked hold ID is not present in the case cache, the selected hold does need to be updated.

At 208, the hold contents from the compliance platform are saved to the corresponding hold in the case cache and, at 210, the hold timestamp associated with the selected hold on the compliance platform is saved to the corresponding hold in the case cache. Thus, after 208 and 210, the selected hold in the case cache matches the selected hold on the compliance platform.

At 212, if holds remain in the set of holds of the selected compliance case, the process returns to 204 to select another hold. Alternatively, if no holds remain in the set of holds, the process proceeds to 214. At 214, if cases remain in the set of compliance cases to be cached, the process returns to 202 to select another case. Alternatively, if no cases remain in the set of compliance cases, the process proceeds to 216.

At 216, team content data of the set of compliance cases is obtained in the form of a list of URL sites and saved to the case cache (e.g., with a current timestamp). In some examples, the team content data includes meeting data, private communication channel data, or the like. As with the case content data above, in some examples, upon caching the obtained team content data, a timestamp associated with the cached data is updated in the cache.

At 218, when the process ends, the case cache has been populated and/or updated with user content data and/or team content data that is up-to-date based on data stored in the compliance platform.

It should be understood that, in some examples, interactions with the compliance platform are limited based on bandwidth, quantity of network connections, or the like. In such examples, the cached case content data is used by the compliance data collector 106 during the described processes to avoid incurring time and/or performance losses due to the limits on interactions with the compliance platform.

Further, in some examples, a compliance platform is configured to throttle or otherwise limit the quantity command time an entity, such as the compliance data collector 106, can use over time. For instance, in an example, the compliance platform tracks the quantity of time that passes from the reception of a command from the compliance data collector 106 to the completion of that command and, if that tracked quantity of time exceeds 30 minutes in an hour, the compliance platform is configured to add wait times to commands from that compliance data collector 106. In some such examples, if the compliance data collector 106 continues to use large quantities of command time, the wait times that are added to its commands are increased (e.g., up to several minutes in some cases). In some such examples, the compliance data collector 106, when executing processes such as process 200, is configured to throttle its own operations such that the initial threshold for added wait times is never reached. For instance, in an example where the command time threshold is 30 minutes, the compliance data collector 106 tracks command time spent and refrains from crossing that threshold (e.g., the compliance data collector 106 stops sending commands temporarily when tracked command time reaches 29 minutes).

FIG. 3 is a flowchart illustrating a method 300 for building a team cache 126 from a team data platform 104. In some examples, the method 300 is executed or otherwise performed by a compliance data collector 106 or other component of a system such as system 100 of FIG. 1.

At 302, a user from a set of users in the case cache is selected. In some examples, the process 300 is configured to be executed after the process 200, such that the set of users in the case cache has just been updated. Further, in some examples, the set of users includes all the users in the case cache while in other examples, the set of users includes a subset of the users in the case cache.

At 304, team data associated with the selected user is accessed and a timestamp associated with that team data is obtained. If the timestamp is older than a defined time threshold (e.g., 48 hours), the process proceeds to 306. Alternatively, if the timestamp is not older than the defined time threshold, the process proceeds to 308. Additionally, or alternatively, in other examples, the decision at 304 is influenced by other features of the team data without departing from the description. For instance, in an example, if team data associated with the selected user is absent or otherwise determined to be incomplete, the process proceeds to 306.

At 306, all team content data from a team data platform associated with the selected user is saved in the team cache and the timestamp of that team content data in the team cache is updated to a current timestamp. In some examples, the team content data includes the members of the team, meeting data associated with the team, context data or other data associated with the team, such as information indicating how the team fits into a larger organization structure.

At 308, a team from a set of teams of the selected user's team data is selected and, at 310, if a timestamp associated with private channel data of the selected team is older than a time threshold (e.g., 48 hours), the process proceeds to 312. Alternatively, if the timestamp of the private channel data of the selected team is not older than the time threshold, the process proceeds to 314.

At 312, all private channel data from the team data platform associated with the selected user and selected team is saved in the team cache and the timestamp associated with the private channel data is updated to a current timestamp. In some examples, private channel data includes data of communication channels that include communications between members of the team and/or people otherwise associated with the team.

At 314, if teams remain to be selected in the set of teams, the process returns to 308 to select another team. Alternatively, if no teams remain to be selected in the set of teams, the process proceeds to 316.

At 316, if users remain to be selected in the set of users, the process returns to 302 to select another user. Alternatively, if no users remain to be selected in the set of users, the process proceeds to 318, at which point the process ends.

In some examples, the team content data obtained from the team data platform in association with different users overlaps (e.g., when two users are on the same team). In some such examples, the process 300 is configured to only obtain and cache such overlapping data once and to link each associated user to that cached data. For instance, in an example, the process 300 caches a set of obtained team content data and adds a timestamp to the cached team content data to indicate that it was cached recently. When overlapping team content data for another user is to be obtained and cached, the process 300 checks the timestamp on the currently cached team content data for that team and determines that another caching of that data is unnecessary because the timestamp is very recent. In other examples, other methods of avoiding repeated caching of overlapping data are used without departing from the description.

Further, in some such examples, the compliance data collector 106, during execution of the process 300 or other processes, is configured to parallelize the performance of the operations such that the time to perform the processes is reduced. For instance, in an example, the process 300 is performed using three parallel threads and the set of users in the case cache are divided evenly between the three threads, such that process 300 is performed by each thread in parallel with each other. In some such examples, the quantity of threads that can be used is based on limitations of the compliance platform or other component of the system and the quantity of threads used is chosen to enable efficient use of resources without exceeding established limitations of such components.

FIG. 4 is a flowchart illustrating a method 400 for updating cases 130-132 on a compliance platform 108 using a case cache 122 and a team cache 126. In some examples, the process 400 is executed or otherwise performed by a compliance data collector 106 and/or another component of a system such as system 100 of FIG. 1. Further, in some such examples, the method 400 uses a case queue for adding content to a case. If any content is found for a user that is not part of the case, the content is added to the case queue. After going through all the users for the case, any content in the case queue is added to the case. In some cases, this significantly increases performance as the content of the case queue can be added in bulk with a single command. Additionally, it reduces the chances for imposed delays to excessive command time. When nothing is left in the case queue to process, the case queue is emptied before beginning with the next case.

At 402, a compliance case from a set of cached compliance cases in the cached case content data (e.g., cached case content data 124) is selected. In some examples, the selected case includes data of all users who are part of the case as well as all the user and team content data associated therewith.

At 404, a user of the selected case is selected and, at 406, if user data of the selected user, such as a user mailbox and/or cloud-based files or storage drive, are not present in the case on the compliance platform, the process proceeds to 408. Alternatively, if such user data of the selected user is present on the compliance platform, the process proceeds to 410.

At 408, the user data of the selected user is added to the case queue. In some examples, the user data added to the case queue includes sites for the user's mailbox and/or cloud-based storage drive, wherein such sites enable the data to which the sites refer to be transferred to the compliance platform at a later time in the process.

At 410, all teams associated with the selected user are obtained from the team cache and, at 412, a team from the obtained teams is selected. In some examples, the team data includes sites that refer to a team data location, a team-associated mailbox, or the like. If, at 414, the team data of the selected team is not present in the case on the compliance platform, the process proceeds to 416. Alternatively, if the team data of the selected team is present in the case on the compliance platform, the process proceeds to 418.

At 416, the team data is added to the case queue. In some examples, adding the team data to the case queue includes adding sites that refer to locations of team data as described above, enabling the process to access the data at those sites later for transfer to the compliance platform.

At 418, all private channels of the selected user and team are obtained from the team cache and, at 420, a private channel is selected from the obtained private channels. In some examples, channel data of private channels includes sites that refer to locations at which data of the private channels can be accessed as described herein. At 422, if channel data of the selected private channel is not present in the case on the compliance platform, the process proceeds to 424. Alternatively, if the channel data of the selected private channel is present in the case on the compliance platform, the process proceeds to 426.

At 424, the channel data of the selected private channel is added to the case queue. In some examples, adding the channel data to the case queue includes adding a site or sites that refer to locations of channel data as described above, enabling the process to access the data at those sites later for transfer to the compliance platform.

At 426, if there are more private channels to be selected from the obtained private channels, the process returns to 420. Alternatively, if there are no more private channels to be selected from the obtained private channels, the process proceeds to 428.

At 428, if there are more teams to be selected from the obtained teams, the process returns to 412. Alternatively, if there are no more teams to be selected from the obtained teams, the process proceeds to 430.

At 430, if there are more users to be selected from the selected case, the process returns to 404. Alternatively, if there are no more users to be selected from the selected case, the process proceeds to 432.

At 432, content in the case queue is added to the compliance platform. In some examples, adding content from the case queue to the compliance platform includes identifying a hold in the compliance case on the compliance platform that has sufficient capacity to hold the content in the case queue and then transferring the content of the case queue to that identified hold. Alternatively, if no hold of the case is identified with sufficient capacity, one or more new holds are created for the case and the content in the case queue is then transferred to the new hold(s) of the case on the compliance platform. In some such examples, the holds of the compliance platform are configured to hold 100 sites and/or 1000 mailboxes.

At 434, if there are more cases to be selected of the set of cached compliance cases, the process returns to 402 to select another compliance case. Alternatively, if there are no more cases to be selected from the set of cached compliance cases, the process proceeds 436, at which point, the process ends.

Further, in some examples, overlapping or redundant user content data and/or team content data across multiple compliance cases is only obtained and provided to the compliance platform once. In such examples, the compliance platform is configured to update the received data in each case with which the received data is associated. In this way, the method 400 reduces the time and resource costs of obtaining and providing redundant data to the compliance platform.

Further, in some such examples, the compliance data collector 106, during execution of the process 400 or other processes, is configured to parallelize the performance of the operations such that the time to perform the processes is reduced. For instance, in an example, the process 400 is performed using two parallel threads and the set of cases in the case cache are divided evenly between the two threads, such that process 400 is performed by each thread in parallel with each other. In some such examples, the quantity of threads that can be used is based on limitations of the compliance platform (e.g., three threads as a limit) or other component of the system and the quantity of threads used is chosen to enable efficient use of resources without exceeding established limitations of such components. For instance, in an example where the compliance platform limits multi-threading to three threads, the method 400 is configured to use two threads for the most part, such that a third thread can be created when necessary in response to failure of one of the other two threads without exceeding the limits of the compliance platform.

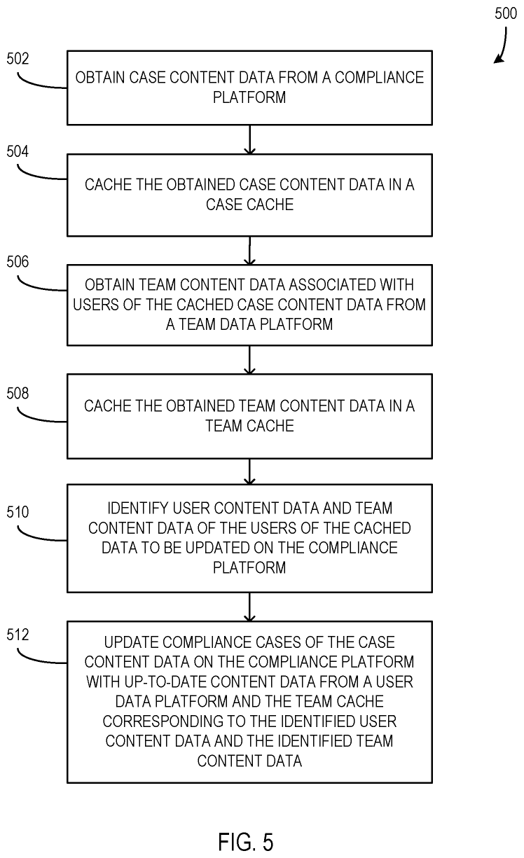

FIG. 5 is a flowchart illustrating a method 500 for caching content data (e.g., user content data 140 and team content data 142) and then updating compliance cases 130-132 on a compliance platform 108 using the cached content data. In some examples, the method 500 is executed or otherwise performed by a compliance data collector 106 and/or other components of a system such as system 100 of FIG. 1.

At 502, case content data is obtained from a compliance platform (e.g., compliance platform 108) and, at 504, the obtained case content data is cached in a case cache (e.g., cached case content data 124 in case cache 122). In some examples, the cached case content data includes a set of compliance cases, and, for each compliance case, a set of users mapped to the compliance case and user content data and/or team content data associated with the set of users. Further, in some examples, the obtaining and caching of the case content data is performed as described above with respect to method 200 of FIG. 2.

In some examples, the user content data associated with a user includes email data associated with a user profile of the user and/or cloud-stored file data associated with the user profile of the user. Additionally, or alternatively, in some examples, the team content data associated with a user includes team data, such as a list of team members, associated with a team of which the user is a member, team meeting data associated with the team of which the user is a member, and/or private communication channel data associated with the team of which the user is a member.

Further, in some examples, obtaining the data of the case content data includes identifying a current subset of data of the cached case content data that is associated with timestamps that are older than a defined timestamp threshold. A set of data that corresponds to the identified current subset of data is then obtained from the compliance platform and the data of the cached case content data is updated with the obtained set of data from the compliance platform. For instance, in such an example, the defined timestamp threshold is set to 24 hours, such that data in the cached case content data associated with timestamps that are older than 24 hours are updated using the data currently on the compliance platform. It should be understood that, in some examples, the compliance platform does not have more up-to-date corresponding data and, in those cases, the method 500 refrains from obtaining the same age or older data from the compliance platform for updating the cached case content data.

At 506, team content data (e.g., team content data 120) associated with users of the cached case content data is obtained from a team data platform (e.g., team data platform 104) and, at 508, the obtained team content data is cached in a team cache (e.g., team cache 126). In some examples, the obtaining and caching of the case content data is performed as described above with respect to method 300 of FIG. 3.

Further, in some examples, obtaining the team content data associated with users of the cached case content data from a team data platform includes identifying a current subset of data of the cached team content data in the team cache that is associated with timestamps that are older than a defined timestamp threshold. A set of data is then obtained from the team data platform that corresponds to the identified current subset of data of the cached team content data in the team cache and the data of the team cache is updated with the obtained set of data from the team data platform. For instance, in such an example, the defined timestamp threshold is set to 48 hours, such that data in the team cache associated with timestamps that are older than 48 hours are updated using the data currently on the team data platform. It should be understood that, in some examples, the team data platform does not have more up-to-date corresponding data and, in those cases, the method 500 refrains from obtaining the same age data from the team data platform for updating the team cache.

At 510, user content data (e.g., user content data 140) and team content data (e.g., team content data 142) to be updated on the compliance platform (e.g., compliance platform 108) are identified. In some examples, the identified user content data and team content data are associated with users of the cached case content data (e.g., cached case content data 124). At 512, compliance cases (e.g., compliance cases 130-132) on the compliance platform are updated with up-to-date content data from a user data platform (e.g., user data platform 102) and the team cache corresponding to the identified user content data and the identified team content data. For instance, in an example, if a user's email data is identified to be updated on the compliance platform, the most up-to-date version of the user's email data is obtained from the user data platform and provided to the compliance platform as described herein.

Further, in some examples, the identification of user content data and team content data at 510 and the update of compliance cases at 512 are performed as described above with respect to method 400 of FIG. 4.

Additionally, or alternatively, in some examples, identifying user content data and team content data to be updated on the compliance platform includes identifying a current subset of user content data of the cached case content data that is associated with timestamps that are older than a defined timestamp threshold and identifying a current subset of team content data of the cached case content data that is associated with timestamps that are older than a defined timestamp threshold. A set of user content data is obtained from the user data platform that corresponds to the identified current subset of user content data and a set of team content data is obtained from the team cache that corresponds to the identified current subset of team content data. The obtained sets of user content data and team content data are then provided to the compliance platform.

In some examples, users and/or cases are added to the cached case content data in order to cause those users and/or cases to be stored on the compliance platform. For instance, in an example where a newly added user is present in the cached case content data, the method 500 identifies the newly added user and obtains a set of user content data from the user data platform that is associated with the newly added user. Then, a set of team content data is obtained from the team data platform and/or the team cache that is associated with the identified newly added user. The obtained sets of user content data and team content data are provided to the compliance platform for storage therein. If the newly added user is associated with an existing case or cases, the data is stored with those case(s). Alternatively, if the newly added user is added as part of starting a new case, a new compliance case is created on the compliance platform and the data of the newly added user is included in the new compliance case therein. Further, in some such examples, the obtained content data of the newly added user is stored in the case cache with associated timestamps to keep the cache up to date with respect to the newly added user.

### Exemplary Operating Environment

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hardcoded machine. In some examples, platform software comprising an operating system 620 or any other suitable platform software is provided on the apparatus 618 to enable application software 621 to be executed on the device. In some examples, automatically caching content data and maintaining that data on a compliance platform as described herein is accomplished by software, hardware, and/or firmware.

In some examples, computer executable instructions are provided using any computer-readable media that are accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; and a memory comprising computer program code, the memory and the computer program code configured to, with the processor, cause the processor to: obtain case content data from a compliance platform, wherein the case content data includes a set of compliance cases and, for each compliance case, a set of users mapped to the compliance case and user content data associated with the set of users; cache the obtained case content data in a case cache; obtain team content data associated with users of the cached case content data from a team data platform; cache the obtained team content data in a team cache; identify user content data and team content data of the users of the cached case content data to be updated on the compliance platform using the cached user content data and the cached team content data; and update compliance cases of the case content data on the compliance platform with up-to-date content data from a user data platform and the team cache corresponding to the identified user content data and the identified team content data, whereby up-to-date user content data and team content data is maintained in the compliance cases of the compliance platform.

An example computerized method comprises: obtaining case content data from a compliance platform, wherein the case content data includes a set of compliance cases and, for each compliance case, a set of users mapped to the compliance case and user content data associated with the set of users; caching the obtained case content data in a case cache; obtaining team content data associated with users of the cached case content data from a team data platform; caching the obtained team content data in a team cache; identifying user content data and team content data of the users of the cached case content data to be updated on the compliance platform using the cached user content data and the cached team content data; and updating compliance cases of the case content data on the compliance platform with up-to-date content data from a user data platform and the team cache corresponding to the identified user content data and the identified team content data, whereby up-to-date user content data and team content data is maintained in the compliance cases of the compliance platform.

One or more computer storage media having computer-executable instructions that, upon execution by a processor, cause the processor to at least: obtain case content data from a compliance platform, wherein the case content data includes a set of compliance cases and, for each compliance case, a set of users mapped to the compliance case and user content data associated with the set of users; cache the obtained case content data in a case cache; obtain team content data associated with users of the cached case content data from a team data platform; cache the obtained team content data in a team cache; identify user content data and team content data of the users of the cached case content data to be updated on the compliance platform using the cached user content data and the cached team content data; and update compliance cases of the case content data on the compliance platform with up-to-date content data from a user data platform and the team cache corresponding to the identified user content data and the identified team content data, whereby up-to-date user content data and team content data is maintained in the compliance cases of the compliance platform.

Alternatively, or in addition to the other examples described herein, examples include any combination of the following:
wherein obtaining case content data includes: identifying a current subset of data of the cached case content data that is associated with timestamps that are older than a defined timestamp threshold; obtaining a set of data from the compliance platform that corresponds to the identified current subset of the cached case content data; and updating the data of the cached case content data with the obtained set of data from the compliance platform.
wherein obtaining the team content data associated with users of the cached case content data from a team data platform includes: identifying a current subset of data of the cached team content data in the team cache that is associated with timestamps that are older than a defined timestamp threshold; obtaining a set of data from the team data platform that corresponds to the identified current subset of data of the cached team content data in the team cache; and updating the data of the team cache with the obtained set of data from the team data platform.
wherein identifying user content data and team content data of the users of the cached case content data to be updated on the compliance platform includes: identifying a current subset of user content data of the cached case content data that is associated with timestamps that are older than a defined timestamp threshold; obtaining a set of user content data from the user data platform that corresponds to the identified current subset of user content data of the cached case content data; identifying a current subset of cached team content data that is associated with timestamps that are older than a defined timestamp threshold; obtaining a set of team content data from the team data platform that corresponds to the identified current subset of cached team content data; and providing the obtained set of user content data and the obtained set of team content data to the compliance platform.
wherein user content data of a user includes at least one of the following: email data associated with a user profile of the user and cloud-stored file data associated with the user profile of the user; and wherein team content data associated with the user includes at least one of the following: team data associated with a team of which the user is a member, team meeting data associated with the team of which the user is a member, and private communication channel data associated with the team of which the user is a member.
wherein identifying user content data and team content data of the users of the cached case content data to be updated on the compliance platform includes: identifying a newly added user of the cached case content data; obtaining a set of user content data from the user data platform that is associated with the identified newly added user; obtaining a set of team content data from the team data platform that is associated with the identified newly added user; and providing the obtained set of user content data and the obtained set of team content data to the compliance platform.
wherein obtaining case content data from a compliance platform and updating compliance cases of the case content data on the compliance platform include sending commands to the compliance platform; and wherein the computerized method further includes: determining a command time limit established by the compliance platform, wherein the command time limit limits a quantity of time used in processing commands over a time interval; measuring command time taken by commands sent to the compliance platform during the time interval; and reducing a frequency of commands sent to the compliance platform during the time interval using the measured command time taken and the determined command time limit, whereby the command time limit is not reached during the time interval based on the sent commands.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining case content data from a compliance platform, wherein the case content data includes a set of compliance cases and, for each compliance case, a set of users mapped to the compliance case and user content data associated with the set of users; exemplary means for caching the obtained case content data in a case cache; exemplary means for obtaining team content data associated with users of the cached case content data from a team data platform; exemplary means for caching the obtained team content data in a team cache; exemplary means for identifying user content data and team content data of the users of the cached case content data to be updated on the compliance platform using the cached user content data and the cached team content data; and exemplary means for updating compliance cases of the case content data on the compliance platform with up-to-date content data from a user data platform and the team cache corresponding to the identified user content data and the identified team content data, whereby up-to-date user content data and team content data is maintained in the compliance cases of the compliance platform.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to, with the processor, cause the processor to:
obtain case content data from a compliance platform, wherein the case content data includes a set of compliance cases and, for each compliance case, a set of users mapped to the compliance case and user content data associated with the set of users;
cache the obtained case content data in a case cache;
obtain team content data associated with users of the cached case content data from a team data platform;
cache the obtained team content data in a team cache;
identify user content data and team content data of the users of the cached case content data to be updated on the compliance platform using the cached user content data and the cached team content data; and
update compliance cases of the case content data on the compliance platform with up-to-date content data from a user data platform and the team cache corresponding to the identified user content data and the identified team content data, whereby up-to-date user content data and team content data is maintained in the compliance cases of the compliance platform.

2. The system of claim 1, wherein obtaining the case content data includes:
identifying a current subset of data of the cached case content data that is associated with timestamps that are older than a defined timestamp threshold;
obtaining a set of data from the compliance platform that corresponds to the identified current subset of the cached case content data; and
updating the data of the cached case content data with the obtained set of data from the compliance platform.

3. The system of claim 1, wherein obtaining the team content data associated with users of the cached case content data from a team data platform includes:
identifying a current subset of data of the cached team content data in the team cache that is associated with timestamps that are older than a defined timestamp threshold;
obtaining a set of data from the team data platform that corresponds to the identified current subset of data of the cached team content data in the team cache; and
updating the data of the team cache with the obtained set of data from the team data platform.

4. The system of claim 1, wherein identifying user content data and team content data of the users of the cached case content data to be updated on the compliance platform includes:
identifying a current subset of user content data of the cached case content data that is associated with timestamps that are older than a defined timestamp threshold;
obtaining a set of user content data from the user data platform that corresponds to the identified current subset of user content data of the cached case content data;
identifying a current subset of cached team content data that is associated with timestamps that are older than a defined timestamp threshold;
obtaining a set of team content data from the team data platform that corresponds to the identified current subset of cached team content data; and
providing the obtained set of user content data and the obtained set of team content data to the compliance platform.

5. The system of claim 1, wherein user content data of a user includes at least one of the following: email data associated with a user profile of the user and cloud-stored file data associated with the user profile of the user; and
wherein team content data associated with the user includes at least one of the following: team data associated with a team of which the user is a member, team meeting data associated with the team of which the user is a member, and private communication channel data associated with the team of which the user is a member.

6. The system of claim 1, wherein identifying user content data and team content data of the users of the cached case content data to be updated on the compliance platform includes:
identifying a newly added user of the cached case content data;
obtaining a set of user content data from the user data platform that is associated with the identified newly added user;
obtaining a set of team content data from the team data platform that is associated with the identified newly added user; and
providing the obtained set of user content data and the obtained set of team content data to the compliance platform.

7. The system of claim 1, wherein obtaining case content data from a compliance platform and updating compliance cases of the case content data on the compliance platform include sending commands to the compliance platform; and
wherein the memory and the computer program code are configured to, with the processor, further cause the processor to:
determine a command time limit established by the compliance platform, wherein the command time limit limits a quantity of time used in processing commands over a time interval;
measure command time taken by commands sent to the compliance platform during the time interval; and
reduce a frequency of commands sent to the compliance platform during the time interval using the measured command time taken and the determined command time limit, whereby the command time limit is not reached during the time interval based on the sent commands.

8. A computerized method comprising:
obtaining case content data from a compliance platform, wherein the case content data includes a set of compliance cases and, for each compliance case, a set of users mapped to the compliance case and user content data associated with the set of users;
caching the obtained case content data in a case cache;
obtaining team content data associated with users of the cached case content data from a team data platform;
caching the obtained team content data in a team cache;
identifying user content data and team content data of the users of the cached case content data to be updated on the compliance platform using the cached user content data and the cached team content data; and
updating compliance cases of the case content data on the compliance platform with up-to-date content data from a user data platform and the team cache corresponding to the identified user content data and the identified team content data, whereby up-to-date user content data and team content data is maintained in the compliance cases of the compliance platform.

9. The computerized method of claim 8, wherein obtaining case content data includes:
identifying a current subset of data of the cached case content data that is associated with timestamps that are older than a defined timestamp threshold;
obtaining a set of data from the compliance platform that corresponds to the identified current subset of the cached case content data; and
updating the data of the cached case content data with the obtained set of data from the compliance platform.

10. The computerized method of claim 8, wherein obtaining the team content data associated with users of the cached case content data from a team data platform includes:
identifying a current subset of data of the cached team content data in the team cache that is associated with timestamps that are older than a defined timestamp threshold;
obtaining a set of data from the team data platform that corresponds to the identified current subset of data of the cached team content data in the team cache; and
updating the data of the team cache with the obtained set of data from the team data platform.

11. The computerized method of claim 8, wherein identifying user content data and team content data of the users of the cached case content data to be updated on the compliance platform includes:
identifying a current subset of user content data of the cached case content data that is associated with timestamps that are older than a defined timestamp threshold;
obtaining a set of user content data from the user data platform that corresponds to the identified current subset of user content data of the cached case content data;
identifying a current subset of cached team content data that is associated with timestamps that are older than a defined timestamp threshold;
obtaining a set of team content data from the team data platform that corresponds to the identified current subset of cached team content data; and
providing the obtained set of user content data and the obtained set of team content data to the compliance platform.

12. The computerized method of claim 8, wherein user content data of a user includes at least one of the following: email data associated with a user profile of the user and cloud-stored file data associated with the user profile of the user; and
wherein team content data associated with the user includes at least one of the following: team data associated with a team of which the user is a member, team meeting data associated with the team of which the user is a member, and private communication channel data associated with the team of which the user is a member.

13. The computerized method of claim 8, wherein identifying user content data and team content data of the users of the cached case content data to be updated on the compliance platform includes:
identifying a newly added user of the cached case content data;
obtaining a set of user content data from the user data platform that is associated with the identified newly added user;
obtaining a set of team content data from the team data platform that is associated with the identified newly added user; and
providing the obtained set of user content data and the obtained set of team content data to the compliance platform.

14. The computerized method of claim 8, wherein obtaining case content data from a compliance platform and updating compliance cases of the case content data on the compliance platform include sending commands to the compliance platform; and
wherein the computerized method further includes:
determining a command time limit established by the compliance platform, wherein the command time limit limits a quantity of time used in processing commands over a time interval;
measuring command time taken by commands sent to the compliance platform during the time interval; and
reducing a frequency of commands sent to the compliance platform during the time interval using the measured command time taken and the determined command time limit, whereby the command time limit is not reached during the time interval based on the sent commands.

15. One or more computer storage media having computer-executable instructions that, upon execution by a processor, cause the processor to at least:
obtain case content data from a compliance platform, wherein the case content data includes a set of compliance cases and, for each compliance case, a set of users mapped to the compliance case and user content data associated with the set of users;
cache the obtained case content data in a case cache;
obtain team content data associated with users of the cached case content data from a team data platform;
cache the obtained team content data in a team cache;
identify user content data and team content data of the users of the cached case content data to be updated on the compliance platform using the cached user content data and the cached team content data; and
update compliance cases of the case content data on the compliance platform with up-to-date content data from a user data platform and the team cache corresponding to the identified user content data and the identified team content data, whereby up-to-date user content data and team content data is maintained in the compliance cases of the compliance platform.

16. The one or more computer storage media of claim 15, wherein obtaining the case content data includes:
identifying a current subset of data of the cached case content data that is associated with timestamps that are older than a defined timestamp threshold;
obtaining a set of data from the compliance platform that corresponds to the identified current subset of the cached case content data; and
updating the data of the cached case content data with the obtained set of data from the compliance platform.

17. The one or more computer storage media of claim 15, wherein obtaining the team content data associated with users of the cached case content data from a team data platform includes:
identifying a current subset of data of the cached team content data in the team cache that is associated with timestamps that are older than a defined timestamp threshold;
obtaining a set of data from the team data platform that corresponds to the identified current subset of data of the cached team content data in the team cache; and
updating the data of the team cache with the obtained set of data from the team data platform.

18. The one or more computer storage media of claim 15, wherein identifying user content data and team content data of the users of the cached case content data to be updated on the compliance platform includes:
identifying a current subset of user content data of the cached case content data that is associated with timestamps that are older than a defined timestamp threshold;
obtaining a set of user content data from the user data platform that corresponds to the identified current subset of user content data of the cached case content data;
identifying a current subset of cached team content data that is associated with timestamps that are older than a defined timestamp threshold;
obtaining a set of team content data from the team data platform that corresponds to the identified current subset of cached team content data; and
providing the obtained set of user content data and the obtained set of team content data to the compliance platform.

19. The one or more computer storage media of claim 15, wherein user content data of a user includes at least one of the following: email data associated with a user profile of the user and cloud-stored file data associated with the user profile of the user; and
wherein team content data associated with the user includes at least one of the following: team data associated with a team of which the user is a member, team meeting data associated with the team of which the user is a member, and private communication channel data associated with the team of which the user is a member.

20. The one or more computer storage media of claim 15, wherein identifying user content data and team content data of the users of the cached case content data to be updated on the compliance platform includes:
identifying a newly added user of the cached case content data;
obtaining a set of user content data from the user data platform that is associated with the identified newly added user;
obtaining a set of team content data from the team data platform that is associated with the identified newly added user; and
providing the obtained set of user content data and the obtained set of team content data to the compliance platform.
